(19) United States
(12) Patent Application Publication
(10) Pub. No.: US 2025/0066681 A1
(43) Pub. Date: Feb. 27, 2025

(54) SUSTAINABLE THERMAL CRACKING METHOD, PRODUCTS THEREOF AND CRACKER FEED

(71) Applicant: Neste Oyj, Espoo (FI)

(72) Inventors: John JAMIESON, Porvoo (FI); Andres MUNOZ GANDARILLAS, Porvoo (FI); Antti OJALA, Porvoo (FI)

(73) Assignee: Neste Oyj, Espoo (FI)

(21) Appl. No.: 18/724,289

(22) PCT Filed: Nov. 21, 2022
(86) PCT No.: PCT/FI2022/050770

§ 371 Date: Jun. 26, 2024

(30) Foreign Application Priority Data
Dec. 27, 2021 (FI) 20216354

(51) Int. Cl. C10G 47/22; C10G 55/04

(52) U.S. Cl. CPC C10G 47/22; C10G 55/04; C10G 2400/04; C10G 2400/20

(57) ABSTRACT

The present disclosure relates to a method of providing a renewable cracker feed obtainable by fractionating an isomeric hydrocarbon composition having an i-paraffins content of 85.0 wt.-% or more and a carbon range in a range of from 20 to 32 into at least a lower-boiling fraction and a higher-boiling fraction, and providing at least part of the lower-boiling fraction or at least part of the higher-boiling fraction as the renewable cracker feed; thermally cracking the renewable cracker feed in a thermal cracking furnace, optionally together with co-feed(s) and/or additive(s); and subjecting an effluent of the thermal cracking furnace to a separation treatment to provide at least a light olefin(s) fraction. A polymer composition obtainable by use of olefin(s) in the light olefin(s) fraction is also disclosed.

### TECHNICAL FIELD

The present invention relates to a method comprising thermal cracking, products obtainable by use of such a method and to a cracker feed usable in such a method.

### BACKGROUND OF THE INVENTION

Thermal cracking, such as steam cracking, is a well-known and established route for upgrading conventional (mineral oil based) material. In recent times, thermal cracking of biogenic material has been investigated, while it was usually tried to achieve direct cracking of a biogenic feed (usually having high oxygen content) or to mimic conventional (fossil) feeds.

The prior art discloses several cracking methods employing hydrocarbon feeds, most of which, however, employ exclusively fossil material. A cracking method employing at least partially a renewable hydrocarbon feed is disclosed in WO 2020/201614 A1. Further, WO 2020/128156 A1 discloses a method comprising thermally cracking a raw material originating from a renewable source and comprising at least 60 wt.-% iso-paraffins. WO2015/101837 A2 discloses a composition comprising paraffin fractions obtained from biological raw material. WO 2021/094655 A1 discloses a method for producing renewable fuels.

High value chemicals produced in the thermal cracking process (such as steam cracking) are ethylene, propylene, butadiene, olefinic C4, benzene, xylene and toluene. Of these high value chemicals, specifically propylene and butadiene are interesting raw materials for special chemicals and polymers.

C4 monoolefins are also valuable products but may require additional refining steps to extract chemical and polymer grades of each individual component. Aromatics are of less importance as there are other routes to their manufacture such as reforming of fossil naphtha. In addition, in steam cracking operations benzene may enrich in a pyrolysis gasoline fraction of the cracking effluent which is typically valorised in fuels. Since there are stringent limitations in the amount of benzene allowable in such fuel products (due to its carcinogenic effects) it may even become an unwanted by-product which requires removal.

In order to introduce bio molecules to the petrochemical value chain, and in view of the above considerations, it is useful to employ a process that maximises the yields to light olefins while suppressing formation of aromatics, in particular benzene.

### BRIEF DESCRIPTION OF THE INVENTION

The present invention was made in view of the above-mentioned problems and it is an object of the present invention to provide an improved method comprising thermal cracking of a renewable cracker feed and products emerging from the method as well as their use and further processing.

The problem underlying the invention is solved by the subject-matters set forth in the independent claims. Further beneficial developments are set forth in dependent claims.

In brief, the present invention relates to one or more of the following items:
1. A method comprising
(a) a step of providing a renewable cracker feed obtainable by fractionating an isomeric hydrocarbon composition having an i-paraffins content of 85.0 wt.-% or more and a carbon range in the range of from 20 to 32 into at least a lower-boiling fraction and a higher-boiling fraction, and providing at least part of the lower-boiling fraction or at least part of the higher-boiling fraction as the renewable cracker feed,
(b) a step of thermally cracking the renewable cracker feed in a thermal cracking furnace, optionally together with co-feed(s) and/or additive(s), and
(c) a step of subjecting the effluent of the thermal cracking furnace of step (b) to a separation treatment to provide at least a light olefin(s) fraction.
2. The method according to item 1, wherein the isomeric hydrocarbon composition has a c_50 value in the range of from 14.0 to 22.0, preferably from 14.0 to 20.0 or from 15.0 to 20.0.
3. The method according to item 2, wherein both the lower-boiling fraction and the higher-boiling fraction have, independently of one another, an i-paraffins content of 92.0 wt.-% or more, preferably 93.0 wt.-% or more, 94.0 wt.-% or more, or 95.0 wt.-% or more.
4. The method according to any one of the preceding items, wherein both the lower-boiling fraction and the higher-boiling fraction have, independently of one another, a ratio (iP3+/IP) between i-paraffins having more than three branches (IP3+) to total i-paraffins (IP) of 0.164 or less, preferably 0.160 or less, 0.155 or less, 0.150 or less.
5. The method according to any one of the preceding items, wherein
   both the lower-boiling fraction and the higher-boiling fraction have, independently of one another, a total content of i-paraffins having more than three branches (iP3+) of 10.50 wt.-% or more, such as 10.50 to 16.00, 11.00 to 15.50, 11.00 to 15.50, 11.00 to 15.00, or 12.00 to 15.00 relative to total paraffins.
6. The method according to any one of the preceding items, wherein
   both the lower-boiling fraction and the higher-boiling fraction have, independently of one another, a cloud point of −10° C. or lower, preferably −15° C. or lower, or −20° C. or lower.
7. The method according to any one of the preceding items, wherein both the lower-boiling fraction and the higher-boiling fraction have, independently of one another, a content of naphthenes in the range of from 0.1 wt.-% to 10.0 wt.-%.
8. The method according to any one of the preceding items, wherein both the lower-boiling fraction and the higher-boiling fraction have, independently of one another, a content of naphthenes of 0.2-10.0 wt.-%, such as 0.5-8.0 wt.-%, 0.5-6.0 wt.-%, 0.6 to 5.8 wt.-%, or 0.8 to 5.6 wt.-%.
9. The method according to any one of the preceding items, wherein both the lower-boiling fraction and the higher-boiling fraction have, independently of one another, a content of olefins of 0.50 wt.-% or less, preferably 0.40 wt.-% or less, 0.30 wt.-% or less, 0.25 wt.-% or less, 0.20 wt.-% or less, 0.15 wt.-% or less, 0.12 wt.-% or less, 0.10 wt.-% or less, 0.07 wt.-% or less, or 0.05 wt.-% or less.
10. The method according to any one of the preceding items, wherein both the lower-boiling fraction and the higher-boiling fraction have, independently of one another, a total content of olefins and naphthenes in the range from 0.1 wt.-% to 10.0 wt.-%.
11. The method according to any one of the preceding items, wherein both the lower-boiling fraction and the higher-boiling fraction have, independently of one another, a total content of olefins and naphthenes of 0.1 wt.-% to 8.0 wt.-%, such as 0.1 wt.-% to 6.5 wt.-%, 0.1 wt.-% to 6.0 wt.-%, 0.2 wt.-% to 5.5 wt.-%, 0.5 wt.-% to 5.5 wt.-%, 0.5 wt.-% to 5.0 wt.-%, 0.8 wt.-% to 5.0 wt.-%, 0.9 wt.-% to 5.0 wt.-%, 1.0 wt.-% to 5.0 wt.-%, 1.1 wt.-% to 5.0 wt.-%, or 1.2 wt.-% to 5.0 wt.-%.
12. The method according to any one of the preceding items, wherein both the lower-boiling fraction and the higher-boiling fraction have, independently of one another, a content of aromatics of 0.80 wt.-% or less, preferably 0.70 wt.-% or less, 0.60 wt.-% or less, 0.50 wt.-% or less, 0.40 wt.-% or less, 0.35 wt.-% or less, 0.30 wt.-% or less, 0.25 wt.-% or less, 0.20 wt.-% or less, or 0.15 wt.-% or less.
13. The method according to any one of the preceding items, wherein both the lower-boiling fraction and the higher-boiling fraction have, independently of one another, a total content of olefins, aromatics and naphthenes of 0.1 wt.-% to 10.0 wt.-%, preferably 0.1 wt.-% to 8.0 wt.-%, 0.1 wt.-% to 6.5 10 wt.-%, 0.2 wt.-% to 6.0 wt.-%, 0.5 wt.-% to 5.5 wt.-%, 0.5 wt.-% to 5.0 wt.-%, 0.8 wt.-% to 5.0 wt.-%, 0.9 wt.-% to 5.0 wt.-%, 1.0 wt.-% to 5.0 wt.-%, 1.1 wt.-% to 5.0 wt.-%, or 1.2 wt.-% to 5.0 wt.-%.
14. The method according to any one of the preceding items, wherein both the lower-boiling fraction and the higher-boiling fraction have, independently of one another, a content of oxygenates of 1000 wt.-ppm or less, preferably 700 wt.-ppm or less, 500 wt.-ppm or less, 300 wt.-ppm or less, 100 wt.-ppm or less, 80 wt.-ppm or less, 60 wt.-ppm or less, 50 wt.-ppm or less, 40 wt.-ppm or less, or 30 wt.-ppm or less.
15. The method according to any one of the preceding items, wherein both the lower-boiling fraction and the higher-boiling fraction have, independently of one another, a modal carbon number in the range of from 11 to 21, preferably from 14 to 20 or from 16 to 18.
16. The method according to any one of the preceding items, wherein both the lower-boiling fraction and the higher-boiling fraction have, independently of one another, a content of C14 to C18 i-paraffins of 70 wt.-% to 95 wt.-%, preferably 75 wt.-% to 91 wt.-%.
17. The method according to any one of the preceding items, wherein both the lower-boiling fraction and the higher-boiling fraction have, independently of one another, a total paraffins content of 93 wt.-% or more, preferably 94 wt.-% or more or 95 wt.-% or more.
18. The method according to any one of the preceding items, wherein
   at least part of the higher-boiling fraction is provided as the renewable cracker feed.
19. The method according to any one of the preceding items, wherein
   the higher-boiling fraction has an interventile carbon number range (IVR) of 5.0 or less, preferably 4.5 or less, 4.0 or less, 3.5 or less, 3.0 or less, 2.5 or less, or 2.3 or less.
20. The method according to any one of the preceding items, wherein
   the higher-boiling fraction has a c_50 value in the range of from 16.5 to 20.0, preferably 16.5 to 19.0, or 17.0 to 18.0.
21. The method according to any one of the preceding items, wherein
   the higher-boiling fraction has a c_50 value of 16.5 or more and an interventile carbon number range (IVR) of 5.0 or less.
22. The method according to any one of the preceding items, wherein
   at least part of the lower-boiling fraction is provided as the renewable cracker feed.
23. The method according to any one of the preceding items, wherein
   the lower-boiling fraction has a c_50 value in the range of from 11.0 to less than 16.5, preferably 12.0 to 16.0, or 14.0 to 16.0.
24. The method according to any one of the preceding items, wherein
   the lower-boiling fraction has an interventile carbon number range (IVR) in the range of from 5.0 to 12.0, preferably 6.0 to 12.0, or 7.0 to 11.0.
25. The method according to any one of the preceding items, wherein
   the lower-boiling fraction has a c_50 value of less than 16.5 and an interventile carbon number range (IVR) in the range of from 5.0 to 12.0.
26. The method according to any one of the preceding items, wherein
   the lower-boiling fraction has a content of compounds having a weight fraction on the modal carbon number in the range of 20 wt.-% to 40 wt.-%, preferably 22 wt.-% to 37 wt.-%, or 25 wt.-% to 35 wt.-%.
27. The method according to any one of the preceding items, wherein
   the lower-boiling fraction has a minimum carbon number (C_min) in the range of from 5 to 8, preferably 5 to 7, such as 5 or 6.
28. The method according to any one of the preceding items, wherein
   the lower-boiling fraction has a maximum carbon number (C_max) in 21.
29. The method according to any one of the preceding items, wherein
   the lower-boiling fraction has a modal carbon number in the range of from 12 to 17, such as 13 to 17, 14 to 16, or 15 to 16.
30. The method according to any one of the preceding items, wherein the lower-boiling fraction has an interquartile carbon number range (IQR) in the range of 1.5 to 4.0, preferably 2.0 to 3.5, or 2.0 to3.0.
31. The method according to any one of the preceding items, wherein the lower-boiling fraction has an interdecile carbon number range (IDR) in the range of 4.0-14.0, 6.0-10.0, 7.0-9.0.
32. The method according to any one of the preceding items, wherein
   the lower-boiling fraction has an interventile carbon number range (IVR) in the range of 6.0-11.0, 7.0-11.0, 8.0-10.5.
33. The method according to any one of the preceding items, wherein
   the lower-boiling fraction has an 80% carbon span (CS_80) in the range of 3.0-9.0, preferably 4.0-8.0, or 4.5-7.0.
34. The method according to any one of the preceding items, wherein
   the lower-boiling fraction has a cloud point of −20° C. or lower, preferably −30° C. or lower, −40° C. or lower, −45° C. or lower, most preferably −50° C. or lower.
35. The method according to any one of the preceding items, wherein
   the higher-boiling fraction has a higher c_50 value than the isomeric hydrocarbon composition and the lower-boiling fraction has a lower c_50 value than the higher-boiling fraction.
36. The method according to any one of the preceding items, wherein
   the higher-boiling fraction has a c_50 value which is at least 0.5 higher, preferably at least 1.0 higher or at least 1.5 higher, than the c_50 value of the isomeric hydrocarbon composition.
37. The method according to any one of the preceding items, wherein
   the lower-boiling fraction has a c_50 value which is at least 0.5 lower, preferably at least 1.0 lower or at least 1.5 lower, than the c_50 value of the higher-boiling fraction.
38. The method according to any one of the preceding items, wherein
   the higher-boiling fraction has a content of compounds having a weight fraction on the modal carbon number in the range of 40-95 wt.-%, 50-92 wt.-%, 60-90 wt.-%, 65-89 wt.-%, 70-88 wt.-%, 75-87 wt.-%, 76-86 wt.-%, or 77-85 wt.-%.
39. The method according to any one of the preceding items, wherein
   the higher-boiling fraction has a minimum carbon number (C_min) in the range of from 8 to 20, preferably 10 to 18, 11 to 17, 12 to 16, or 13 to 16.
40. The method according to any one of the preceding items, wherein
   the higher-boiling fraction has a maximum carbon number (C_max) in the range of from 22 to 40, preferably 24 to 38, 26 to 36, 26 to 35, 27 to 34
41. The method according to any one of the preceding items, wherein
   the higher-boiling fraction has a modal carbon number in the range of from 17 to 22, preferably 18 to 21, 18 to 20, or 18 to 19.
42. The method according to any one of the preceding items, wherein
   the higher-boiling fraction has the higher-boiling fraction has an interquartile carbon number range (IQR) in the range of 0.1-3.0, 0.2-2.0, 0.3-1.0, 0.4-0.8.
43. The method according to any one of the preceding items, wherein
   the higher-boiling fraction has an interdecile carbon number range (IDR) in the range of 0.5-4.0, 0.6-3.0, 0.7-2.0, 0.8-1.6.
44. The method according to any one of the preceding items, wherein
   the higher-boiling fraction has an interventile carbon number range (IVR) in the range of 1.1-5.0, 1.3-4.0, 1.4-3.5, 1.6-3.2, 1.8-3.0, 1.8-2.8.
45. The method according to any one of the preceding items, wherein
   the higher-boiling fraction has an 80% carbon span (CS_80) in the range of 0.1-3.0, preferably 0.2-2.5, 0.3-2.0, 0.4-1.6, or 0.5-1.4.
46. The method according to any one of the preceding items, wherein
   the higher-boiling fraction has a cloud point of −10° C. or lower, preferably −15° C. or lower, −20° C. or lower, −25° C. or lower, or −27° C. or lower.
47. The method according to any one of the preceding items, wherein the thermal cracking step (b) is conducted at a coil outlet temperature (COT) selected from the range from 780° C. to 900° C., preferably from 805° C. to 865° C., more preferably from 815° C. to 850° C.
48. The method according to any one of the preceding items, wherein the thermal cracking step (b) is conducted at a coil outlet pressure (COP) selected from the range from 1.3 bar to 6.0 bar, preferably from 1.3 bar to 3.0 bar.
49. The method according to any one of the preceding items, wherein the thermal cracking step (b) is a steam cracking step.
50. The method according to any one of the preceding items, wherein the thermal cracking step (b) is conducted in the presence of a thermal cracking diluent at a dilution within a range from 0.10 to 0.80, preferably from 0.25to 0.70, such as 0.35 to 0.50.
51. The method according to any one of the preceding items, comprising a purification treatment to remove at least one of methyl acetylene, propadiene, CO, CO₂ and C₂H₂, preferably at least one of CO, CO₂ and C₂H₂, as a purification stage (c′) in the step (c) of separating at least the light olefin(s) fraction from the effluent of the thermal cracking furnace of step (b).
52. The method according to any one of the preceding items, comprising performing one or more further cracking operation(s) to provide further cracking effluent(s), wherein
   step (c) further comprises adding the further effluent(s) and/or fraction(s) thereof before and/or during the separation treatment.
53. The method according to any one of the preceding items, wherein the thermal cracking in step (b) is carried out in the presence of co-feed(s).
54. The method according to the preceding item, wherein the content of the renewable cracker feed in the total cracker feed is in the range of from 10 wt.-% to 100 wt.-%, preferably 20 wt.-% to 100 wt.-%, 30 wt.-% to 100 wt.-%, 40 wt.-% to 100 wt.-%, 50 wt.-% to 100 wt.-%, 60 wt.-% to 100 wt.-%, 70 wt.-% to 100 wt.-%, 80 wt.-% to 100 wt.-%, or 90 wt.-% to 100 wt.-%, wherein the total cracker feed refers to the renewable cracker feed plus optional co-feed(s) and optional additive(s).
55. The method according to any one of the preceding items, wherein the co-feed(s) comprise a fossil hydrocarbon co-feed.
56. The method according to any one of the preceding items, wherein the co-feed(s) comprise a naphtha range feed, a diesel range feed, an aviation fuel range feed, a marine fuel range feed, or a gas oil range feed.
57. The method according to any one of the preceding items, wherein the total cracker feed has a sulphur content in the range of from 20 to 300 ppm by weight, preferably 20 to 250 ppm by weight, more preferably 20 to 100 ppm by weight, and even more preferably 50 to 65 ppm by weight.
58. The method according to any one of the preceding items, wherein the step (a) of providing the renewable cracker feed comprises
   subjecting an oxygenate bio-renewable feed to hydrotreatment comprising at least hydrodeoxygenation, and to hydroisomerisation, to provide at least an isomerised deoxygenated stream,
   subjecting at least part of the isomerised deoxygenated stream to fractionation and recovering at least the isomeric hydrocarbon composition, and
   subjecting at least part of the isomeric hydrocarbon composition to a further fractionation to provide at least the lower-boiling fraction and the higher-boiling fraction.
59. The method according to item 58, wherein the hydroisomerisation is conducted in the same hydrotreatment stage as the hydrodeoxygenation, and/or wherein the hydroisomerisation is conducted in a further hydrotreatment stage after the hydrotreatment comprising at least hydrodeoxygenation.
60. The method according to item 58 or 59, comprising gas-liquid separation after the hydrotreatment comprising at least hydrodeoxygenation and/or after the further hydrotreatment, and recovering at least one gaseous stream and the isomerised deoxygenated stream.
61. The method according to item 60, further comprising subjecting the gaseous stream to a propane separation process to provide a stream enriched in propane and a stream depleted in propane.
62. The method according to item 61, further comprising subjecting at least part of the propane from the stream enriched in propane to dehydrogenation, preferably catalytic dehydrogenation, to produce propylene.
63. The method according to any one of the preceding items, wherein the renewable cracker feed is obtainable by:
   subjecting an oxygenate bio-renewable feed to hydrotreatment comprising at least hydrodeoxygenation, to hydroisomerisation and to gas-liquid separation, to provide an isomerised deoxygenated stream,
   feeding the isomerised deoxygenated stream to a first distillation column, preferably a stabilisation column, to obtain at least a naphtha range fraction and a stabilized heavy liquid fraction, and
   feeding at least part of the stabilized heavy liquid fraction as the isomeric hydrocarbon composition to a second distillation column and recovering at least the lower-boiling fraction and the higher-boiling fraction.
64. The method according to any one of items 58 to 63, wherein the isomerised deoxygenated stream has an i-paraffins content of at least 65 wt.-%, preferably at least 70 wt.-%, at least 75 wt.-%, at least 80 wt.-%, at least 85 wt.-% or at least 90 wt.-%.
65. The method according to any one of the preceding items, further comprising derivatisation of at least part of the light olefin(s) to obtain one or more derivate(s) of the light olefin(s) as bio-monomer(s), such as acrylic acid, acrylonitrile, acrolein, propylene oxide, ethylene oxide, 1,4-butanediol, 1,2-butanediol, 1,3-butanediol, 2,3-butanediol, adiponitrile, hexamethylene diamine (HMDA), hexamethylene diisocyanate (HDI), (methyl) methacrylate, ethylidene norboreen, 1,5,9-cyclododecatriene, sulfolane, 1,4-hexadiene, tetrahydrophthalic anhydride, valeraldehyde, 1,2-butyloxide, n-butyl mercaptan, o-sec-butylphenol, propylene, octene and sec-butyl alcohol.
66. The method according to any one of the preceding items, wherein the renewable cracker feed is obtainable by a method comprising subjecting an oxygenate bio-renewable feed to hydrotreatment comprising at least hydrodeoxygenation, and to hydroisomerisation.
at least part of the lower-boiling fraction is subjected to the thermal cracking step (c) in a first thermal cracking furnace and at least part of the higher-boiling fraction is subjected to the thermal cracking step (c) in a second thermal cracking furnace.
68. The method according to any one of the preceding items, wherein
   at least part of the lower-boiling fraction and at least part of the higher-boiling fraction are alternately subjected to the thermal cracking step (c).
69. The method according to any one of the preceding items, wherein
   at least part of the lower-boiling fraction and at least part of the higher-boiling fraction are alternately subjected to the thermal cracking step (c) in the same thermal cracking furnace.
70. The method according to any one of the preceding items, wherein
   at least part of the lower-boiling fraction is subjected to the thermal cracking step (c) and at least part of the higher-boiling fraction is recovered as a specialty fluid or component thereof, such as an electrotechnical fluid, lubricant, coolant or component thereof, and/or as a fuel component, such as a marine fuel component.
71. The method according to any one of the preceding items, wherein
   at least part of the higher-boiling fraction is subjected to the thermal cracking step (c) and at least part of the lower-boiling fraction is recovered as a fuel component, preferably as an aviation fuel component.
72. The method according to any one of the preceding items, wherein
   a part of the lower-boiling fraction is subjected to the thermal cracking step (c) and another part of the lower-boiling fraction is recovered as a fuel component, preferably as an aviation fuel component.
73. The method according to any one of the preceding items, wherein
   a part of the higher-boiling fraction is subjected to the thermal cracking step (c) and another part of the higher-boiling fraction is recovered as a specialty fluid or component thereof, such as an electrotechnical fluid, lubricant, coolant or component thereof, and/or as a fuel component, such as a marine fuel component.
74. The method according to any one of the preceding items, wherein
   the lower-boiling fraction has a content of hydrocarbons having less than 18 carbon atoms (<C18) of 55 wt.-% or more, preferably 60 wt.-% or more, 65 wt.-% or more, 70 wt.-% or more, 75 wt.-% or more or 80 wt.-% or more.
75. The method according to any one of the preceding items, wherein
   the lower-boiling fraction has a ratio (≥C18/<C18) between the content of hydrocarbons having 18 or more carbon atoms (≥C18) and the content of hydrocarbons having less than 18 carbon atoms (<C18) of 0.90 or less, preferably 0.85 or less, 0.80 or less, 0.70 or less, 0.60 or less, 0.50 or less, 0.40 or less or 0.30 or less.
76. The method according to any one of the preceding items, wherein
   the higher-boiling fraction has a content of hydrocarbons having 18 or more carbon atoms (≥C18) of 50 wt.-% or more, preferably 55 wt.-% or more, 60 wt.-% or more, 65 wt.-% or more, 70 wt.-% or more, 75 wt.-% or more or 80 wt.-% or more.
77. The method according to any one of the preceding items, wherein
   the higher-boiling fraction has a ratio (≥C18/<C18) between the content of hydrocarbons having 18 or more carbon atoms (≥C18) and the content of hydrocarbons having less than 18 carbon atoms (<C18) of 1.0 or more, preferably 1.5 or more, 2.0 or more, 3.0 or more, 4.0 or more, 5.0 or more, or 6.0 or more.
78. The method according to any one of the preceding items, further comprising
   (e) a step of (co) polymerizing at least one of the light olefin(s) separated in step (c) and/or at least one of the bio-monomer(s), optionally together with other (co) monomer(s) and/or after optional further purification, to produce a biopolymer composition.
79. The method according to item 78, wherein the biopolymer composition is further processed to produce a sanitary article, a construction material, a packaging material, a coating composition, a paint, a decorative material, such as a panel, an interior part of a vehicle, such as an interior part of a car, a rubber composition, a tire or tire component, a toner, a personal health care article, a part of a consumer good, a part or a housing of an electronic device, a film, a moulded product, a gasket, optionally together with other components.
80. A biopolymer composition obtainable by the method according to items 78 or79.

### BRIEF DESCRIPTION OF DRAWINGS

FIG. 1 illustrates linear interpolation for obtaining c_50 value (graph A) and carbon span at 80% (graph B).

### DETAILED DESCRIPTION OF THE INVENTION

In the present invention, unless specified otherwise, contents and content ratios are provided on a weight basis.

Furthermore, i-paraffins (also referred to as iso-paraffins) refer to branched non-cyclic alkanes, and n-paraffins (also referred to as normal-paraffins) refer to linear non-cyclic alkanes. Total paraffins content refers to the summed content of i-paraffins and n-paraffins. Similarly, olefins refer to linear or branched non-cyclic alkenes, including multiple unsaturated. Naphthenes refer to cyclic non-aromatic branched or non-branched alkanes, alkenes or alkynes, including multiple unsaturated. Aromatics refer to compounds having at least one aromatic ring.

Contents of n-paraffins, i-paraffins, olefins, naphthenes and aromatics can be determined using the PIONA method, which is a GCxGC analysis method, as published by Pyl et al in Journal of Chromatography A, 1218 (2011) 3217-3223 for the GCxGC description. Regarding this publication, for samples that have been subjected to high severity hydroisomerisation the primary column and secondary column are preferably reversed to enhance separation and identification of the isoparaffins from n-paraffins.

In the present context, the term “renewable” or “bio-based” or “bio-” refers to a material which is derived from renewable or biological sources in full or in part. Carbon atoms of renewable or biological origin comprise a higher number of unstable radiocarbon (¹⁴C) atoms compared to carbon atoms of fossil origin. Therefore, it is possible to distinguish between carbon compounds derived from renewable or biological sources or raw material and carbon compounds derived from fossil sources or raw material by analysing the ratio of ¹²C and ¹⁴C isotopes. Thus, a particular ratio of said isotopes (yielding the “biogenic carbon content”) can be used as a “tag” to identify renewable carbon compounds and differentiate them from non-renewable carbon compounds. The isotope ratio does not change in the course of chemical reactions. Examples of a suitable method for analysing the biogenic carbon content are DIN 51637 (2014), ASTM D6866 (2020) and EN 16640 (2017). The content of carbon from biological or renewable sources is expressed as the biogenic carbon content meaning the amount of biogenic carbon in the material as a weight percent of the total carbon (TC) in the material. As used herein, the biogenic carbon content is determined in accordance with EN 16640 (2017). In the present invention, the term “renewable” or “bio-based” or “bio-” preferably refers to a material having a biogenic carbon content in the range of from 1% to 100%.

In particular, the biogenic carbon content of the isomeric hydrocarbon composition and/or of the renewable cracker feed, which may also be referred to as bio-based cracker feed is preferably more than 5% and up to 100%, such as more than 20%, more than 40%, more than 50%, more than 60% or more than 70%, more than 80%, more than 90%, or more than 95%, and may even be about 100%. The biogenic carbon content of the oxygenate bio-renewable feed is preferably more than 50% and up to 100%, preferably more than 60% or more than 70%, preferably more than 80%, more preferably more than 90% or more than 95%, even more preferably about 100%.

The biogenic carbon content of the renewable thermal cracking effluent of the present invention may be below 1%, but is preferably at least 1% and up to 100%, such as at least 2%, at least 5%, at least 10%, at least 20%, at least 40%, at least 50%, at least 75%, at least 90%, or about 100%.

The biogenic carbon content of the effluent of the thermal cracking furnace of step (b), and of products and intermediates downstream the cracking step (b) may be below 1%, but is preferably at least 1% and up to 100%, such as at least 2%, at least 5%, at least 10%, at least 20%, at least 40%, at least 50%, at least 75%, at least 90%, or about 100%.

In particular, the biogenic carbon content of the light olefin(s) (fraction) and/or the bio-monomer and/or the biopolymer composition may be below 1%, but is preferably at least 1% and up to 100%, such as at least 2%, at least 5%, at least 10%, at least 20%, at least 40%, at least 50%, at least 75%, at least 90%, or about 100%.

By the term “optionally” or “optional”, a characteristic, feature or step that may be present, but is not necessarily required for carrying out the invention, is meant.

Unless indicated otherwise, all test method standards referred to in this text are the latest versions on Dec. 1, 2021.

### Thermal Cracking Method

The method of the present invention will be described first.

The present invention relates to a sustainable thermal cracking method. Specifically, the present invention relates to a method employing a feed which has heretofore not been used for thermal cracking and which shows surprisingly good results in thermal cracking. The method of the present invention method comprises a step (a) of providing a renewable cracker feed obtainable by fractionating an isomeric hydrocarbon composition having an i-paraffins content of 85.0 wt.-% or more and a carbon range in the range of from 20 to 32 into at least a lower-boiling fraction and a higher-boiling fraction, and providing at least part of the lower-boiling fraction or at least part of the higher-boiling fraction as the renewable cracker feed, a step (b) of thermally cracking the renewable cracker feed in a thermal cracking furnace, optionally together with co-feed(s) and/or additive(s), and a step (c) of subjecting the effluent of the thermal cracking furnace of step (b) to a separation treatment to provide at least a light olefin(s) fraction.

The method of the present invention provides a light olefin(s) fraction. The method may comprise further purification of the light olefin(s) fraction to provide one or more light olefins, preferably of industry grade or even polymer grade.

In the present invention, the lower-boiling fraction and a higher-boiling fraction are obtainable by fractionating the isomeric hydrocarbon composition. Accordingly, depending on the sharpness of the fractionation (distillation), the respective fractions may have overlapping boiling ranges. As a result of the fractionation, the higher-boiling fraction will usually contain a higher amount of heavier (higher-boiling) components and the lower-boiling fraction will usually contain a higher amount of lighter (lower-boiling) components.

The isomeric hydrocarbon composition preferably has a c_50 value in the range of from 14.0 to 22.0, preferably from 14.0 to 20.0 or from 15.0 to 20.0.In the present invention, the c_50 value is the fractional carbon number representing 50 wt.-% sample. Details for calculating the c_50 value and other fractional carbon numbers are provided below. The carbon range refers to the difference between C_max and C_min (carbon range=C_max-C_min), where C_max (highest occurring carbon number) and C_min (lowest occurring carbon number) are determined by PIONA (GCxGC method described herein), and for determination of C_min and C_max carbon numbers having a measured abundancy of 0.10 wt.-% or less are assumed to be absent. In other words, carbon numbers having a measured abundancy of 0.10 wt.-% or less are not considered when determining C_min and C_max, and thus when determining the carbon range.

The inventors surprisingly found that fractionation of the isomeric hydrocarbon composition having a high i-paraffins content of 85% or more into at least two fractions, each of the resulting fractions shows thermal cracking properties which are superior over the isomeric hydrocarbon composition. Conventionally, such separated fractions were used as a fuel or as special fluids. While part of the lower-boiling fraction and/or the higher-boiling fraction may still be employed for such purposes, at least a part of the lower-boiling fraction or at least a part of the higher-boiling fraction is employed as renewable cracker feed in the method of the present invention. Since these fractions are based on a renewable raw material, the method achieves improved sustainability. In addition, since it may be difficult (or costly) to produce the isomeric hydrocarbon composition in such a way that (exactly) the actually needed or requested relative amounts of lower-boiling fraction and higher-boiling fraction, as used for fuel or special fluids purposes, are produced, the present invention can further upgrade the excess materials which would otherwise be stored or even burnt. Using only a part of the lower-boiling fraction or the higher-boiling fraction may, for example be accomplished by simply splitting a stream of the lower-boiling fraction or of the higher-boiling fraction into two streams or aliquots/aliquants for further processing or by batch-wise directing a stream or batch of these fractions to different processing routes.

In the present invention, the higher-boiling fraction or the lower-boiling fraction are employed as the renewable cracker feed. It is also possible that both fractions or part(s) thereof are employed as the renewable cracker feed of the present invention. In this case, however, the higher-boiling fraction and the lower-boiling fraction must be thermally cracked separately, i.e. not mixed. For example, the higher-boiling fraction and the lower-boiling fraction must not be used as the renewable cracker feed in the same furnace at the same time.

Preferably, both the lower-boiling fraction and the higher-boiling fraction have, independently of one another, an i-paraffins content of 92.0 wt.-% or more. This means that both fractions independently have an i-paraffins content of 92.0 wt.-% or more (i.e. in the range of from 92.0 wt.-% to 100 wt.-%), but not necessarily the same i-paraffins content as long as both fractions have an i-paraffins content within that range. The i-paraffins content may further preferably be, independently of one another, 93.0 wt.-% or more, 94.0 wt.-% or more, or 95.0 wt.-% or more. A high i-paraffins content of the renewable cracker feed results in lower viscosity and thus facilitates handling properties. Moreover, it has been found that this high i-paraffins content results in favourable cracking properties, in particular improved yield of valuable light olefins (VLO).

When a content is referred to in the present invention, this content is based on the material as a whole. For example, the lower-boiling fraction having a content of i-paraffins of 92.0 wt.-% or more means that the content of i-paraffins is 92.0 wt.-% or more based on the total weight of the lower-boiling fraction.

Preferably, both the lower-boiling fraction and the higher-boiling fraction have, independently of one another, a ratio (iP3+/iP) between i-paraffins having more than three branches (IP3+) to total i-paraffins (iP) of 0.164 or less, more preferably 0.160 or less, 0.155 or less, 0.150 or less. A relatively low amount of IP3+ components results in a reduced yield of aromatics, in particular benzene and thus improves the value of the cracking effluent for use in polymer chemistry and other fields where aromatics should be removed before further use.

The content of i-paraffins having more than three branches (IP3+) may be determined by the method disclosed in WO 2020/201614 A1, which is herewith incorporated by reference in its entirety. Specifically, the content of i-paraffins having more than three branches (IP3+) may be determined by the following method:

N-paraffins and i-paraffin contents in the sample are analysed by gas chromatography (GC). The samples is analysed as such, without any pretreatment. The method is suitable for hydrocarbons in the C2-C36 range. N-paraffins and groups of i-paraffins (C1-, C2-, C3-substituted and ≥C3-substituted) are identified using mass spectrometry and a mixture of known n-paraffins in the range of C2-C36. The chromatograms are split into three groups of paraffins (C1-, C2-/C3-and >C3-substituted i-paraffins/n-paraffin), or into two groups of paraffins (C1-/C2-/C3-and ≥C3-substituted i-paraffins/n-paraffin), by integrating the groups into the chromatogram baseline right after n-paraffin peak. N-paraffins are separated from ≥C3-substituted i-paraffins (iP3+) by integrating the n-paraffin peak tangentially from valley to valley. Compounds or compound groups are quantified by normalization using relative response factor of 1.0 to all hydrocarbons. The limit of quantitation for individual compounds is usually 0.01 wt-%. Suitable settings of the GC are shown below:

| | GC |
|---|---|
| Injection | split/splitless-injector |
| | Split 80:1 (injection volume 0.2 μL) |
| Column | DB ™-5 (length 30 m, i.d. 0.25 m, |
| | phase thickness 0.25 μm) |
| Carrrie gas | He |
| Detector | FID (flame ionization detector) |
| GC program | 30° C. (2 min) - 5° C./min - 300° C. (30 min), |
| | constant flow 1.1 mL/min) |

Preferably, both the lower-boiling fraction and the higher-boiling fraction have, independently of one another, a total content of i-paraffins having more than three branches (iP3+) of 10.50 wt.-% or more, such as 10.50 to 16.00, 11.00 to 15.50, 11.00 to 15.50, 11.00 to 15.00, or 12.00 to 15.00 relative to total paraffins. Total paraffins refer to the summed amount of n-paraffins and i-paraffins. In the context of the present invention, the branches of the i-paraffin are typically methyl branches.

Preferably, both the lower-boiling fraction and the higher-boiling fraction have, independently of one another, a cloud point of −10° C. or lower, preferably −15° C. or lower, or −20° C. or lower, such as in the range of from −70° C. to −10° C.

In the present invention, the cloud point may be determined in accordance with ASTM D7689.

Preferably, both the lower-boiling fraction and the higher-boiling fraction have, independently of one another, a content of naphthenes in the range of from 0.1 wt.-% to 10.0 wt.-% based on the total weight of the renewable cracker feed. In high-severity isomerisation, some degree of cyclisation (formation of naphthenes) may occur. According to the present invention, the content of naphthenes in the lower-boiling fraction and the higher-boiling fraction and thus in the renewable cracker feed should be low but needs not be 0 wt.-%. That is, naphthenes may be present to a certain extent and need not be removed. Naphthenes convert easily to aromatics, which are compounds possibly reacting to coke but not to desired products. Thus, it is preferred that the naphthenes content is low.

For example, the content of naphthenes may be, independently of one another, 0.2 wt.-% to 10.0 wt.-%, such as 0.5 wt.-% to 8.0 wt.-%, 0.5 wt.-% to 6.0 wt.-%, 0.6 wt.-% to 5.8 wt.-%, or 0.8 wt.-% to 5.6 wt.-%.

Preferably, both the lower-boiling fraction and the higher-boiling fraction have, independently of one another, a content of olefins of 0.50 wt.-% or less, preferably 0.40 wt.-% or less, 0.30 wt.-% or less, 0.25 wt.-% or less, 0.20 wt.-% or less, 0.15 wt.-% or less, 0.12 wt.-% or less, 0.10 wt.-% or less, 0.07 wt.-% or less, or 0.05 wt.-% or less. Olefins are undesired components in the renewable cracker feed, in the lower-boiling fraction and in the higher-boiling fraction of the present invention. That is, the inventors found that olefins have a strong coking tendency which is even higher than that of aromatics and, therefore, the content of olefins should be kept low. The olefins content may, independently of one another, be 0%, i.e. no detectable amounts of olefins contained.

Preferably, both the lower-boiling fraction and the higher-boiling fraction have, independently of one another, a total content of olefins and naphthenes in the range from 0.1 wt.-% to 10.0 wt.-%. The total content olefins and naphthenes refers to the summed content of olefins and naphthenes. More preferably, the total content of olefins and naphthenes is, independently of one another, 0.1 wt.-% to 8.0 wt.-%, such as 0.1 wt.-% to 6.5 wt.-%, 0.1 wt.-% to 6.0 wt.-%, 0.2 wt.-% to 5.5 wt.-%, 0.5 wt.-% to 5.5 wt.-%, 0.5 wt.-% to 5.0 wt.-%, 0.8 wt.-% to 5.0 wt.-%, 0.9 wt.-% to 5.0 wt.-%, 1.0 wt.-% to 5.0 wt.-%, 1.1 wt.-% to 5.0 wt.-%, or 1.2 wt.-% to 5.0 wt.-%.

Preferably, both the lower-boiling fraction and the higher-boiling fraction have, independently of one another, a content of aromatics of 0.80 wt.-% or less, preferably 0.70 wt.-% or less, 0.60 wt.-% or less, 0.50 wt.-% or less, 0.40 wt.-% or less, 0.35 wt.-% or less, 0.30 wt.-% or less, 0.25 wt.-% or less, 0.20 wt.-% or less, or 0.15 wt.-% or less. Aromatics, such as benzene, do not react into desired products. Rather, they tend to react to coke (i.e. they are coke precursors). Their presence in thermal cracking thus reduces the yield of the desired products and their content should be low. In the present invention, the content of aromatics is preferably low and may be 0.00%. The content of aromatics may be determined by the PIONA analysis.

Preferably, both the lower-boiling fraction and the higher-boiling fraction have, independently of one another, a total content of olefins, aromatics and naphthenes of 0.1 wt.-% to 10.0 wt.-%, preferably 0.1 wt.-% to 8.0 wt.-%, 0.1 wt.-% to 6.5 wt.-%, 0.2 wt.-% to 6.0 wt.-%, 0.5 wt.-% to 5.5 wt.-%, 0.5 wt.-% to 5.0 wt.-%, 0.8 wt.-% to 5.0 wt.-%, 0.9 wt.-% to 5.0 wt.-%, 1.0 wt.-% to 5.0 wt.-%, 1.1 wt.-% to 5.0 wt.-%, or 1.2 wt.-% to 5.0 wt.-%. Naphthenes, aromatics and olefins are coke precursors and their content should be low. However, since it may be laborious to strongly reduce the content of all of these components, certain contents thereof can be tolerated. Nevertheless, their total content may be, independently of one another, down to 0%, including 0%.

Preferably, both the lower-boiling fraction and the higher-boiling fraction have, independently of one another, a content of oxygenates of 1000 wt.-ppm or less, preferably 700 wt.-ppm or less, 500 wt.-ppm or less, 300 wt.-ppm or less, 100 wt.-ppm or less, 80 wt.-ppm or less, 60 wt.-ppm or less, 50 wt.-ppm or less, 40 wt.-ppm or less, or 30 wt.-ppm or less. Oxygenates mean herein molecules containing carbon and hydrogen and further containing covalently bound oxygen in the structure (molecule). In the present invention, low amounts of oxygenates are preferred, including absence of oxygenates. On the other hand, in particular when employing e.g. 10 wt.-% or more of a low-oxygenate co-feed (e.g. a fossil hydrocarbon co-feed), higher values, such as from 100 wt.-ppm to 1000 wt.-ppm may be used, independently of one another. In such a case, the effort for minimizing oxygenate content is minimized which increases overall efficiency of the process.

Preferably, both the lower-boiling fraction and the higher-boiling fraction have, independently of one another, a modal carbon number in the range of from 11 to 21, preferably from 14 to 20 or from 16 to 18.

Preferably, both the lower-boiling fraction and the higher-boiling fraction have, independently of one another, a content of C14 to C18 i-paraffins of 70 wt.-% to 95 wt.-%, preferably 75 wt.-% to 91 wt.-%. In the present invention, the content of C14 to C18 i-paraffins may be determined by the same measurement method as employed for determining the iP3+ content.

Preferably, both the lower-boiling fraction and the higher-boiling fraction have, independently of one another, a total paraffins content of 93 wt.-% or more, preferably 94 wt.-% or more or 95 wt.-% or more.

When both the higher-boiling fraction and the lower-boiling fraction have similar properties, such as cloud point, modal carbon number and/or i-paraffins content, then it is possible to easily switch from providing only (part of) the lower-boiling fraction as the renewable cracker feed to providing only (part of) the higher-boiling fraction as the renewable cracker feed. That is, in such a case, these fractions provide roughly the same desired product slates and benefits in thermal cracking, at least on general level. In such a case, the other fraction can then flexibly be used for another high-value-adding purpose according to demand.

Conventionally, an isomerisation treatment resulting in a high i-paraffins content simultaneously resulted in a high content of multi-branched i- paraffins, in particular i-paraffins having more than three branches. Various methods can be used to achieve a high share of i-paraffins while nevertheless producing only low amounts of IP3+ components. For example, it may be possible to reduce the severity of the isomerisation treatment (e.g. reducing temperature). In some cases, reduced isomerisation temperature may, however, require much longer residence times, which may similarly increase the yield of IP3+ components. In this case, it may be favourable to increase the isomerisation temperature and simultaneously reduce the residence time. Alternatively or in addition, the catalyst for isomerisation can be appropriately selected. For example, it is possible to use a catalyst with specific pore structure in which the component which is catalytically active for isomerisation is provided within small pores such that mainly or only linear paraffins can reach the active site. Such shape-selective catalysts are commercially available.

Preferably, the higher-boiling fraction has an interventile carbon number range (IVR) of 5.0 or less, preferably 4.5 or less, 4.0 or less, 3.5 or less, 3.0 or less, 2.5 or less, or 2.3 or less. An IVR within this range indicates that the higher-boiling fraction is a rather narrow

The IVR is the calculated carbon number range determined from a linear interpolation of data (accumulated content vs. carbon number) obtained from PIONA carbon number analysis. Similarly, IDR, IQR, and c_50 are determined from a linear interpolation of data (accumulated content vs. carbon number) obtained from PIONA carbon number analysis.

The IVR is the carbon number range containing 90% of the mass (i.e. from 5 wt.-% to 95 wt.-%). Similarly, the IQR (interquartile range) is the carbon number range containing 50% of mass from 25 wt.-% to 75 wt.-% and the IDR (interdecile range) is the carbon number range containing 80% of mass from 10 wt.-% to 90 wt.-%. Linear interpolation means that a content range between two carbon numbers is assumed to be linear. For example a sample containing 0% C1, 0% C2, 0% C3, 5% C4, 5% C5 and 8% C6 will have a c_2.5 value (i.e. fractional carbon number representing 2.5 wt.-% of the sample) of 3.5 (carbon number) even though C4 is the lowest carbon number which is actually present. The c_5 (c_05) value (fractional carbon number representing 5 wt.-% sample) is 4 (C4) and the c_10 value (10 wt.-%) is 5 (C5), since the accumulated amount of C1+C2+C3+C4+C5 is exactly 10 wt.-%. The c_15 value (15 wt.-%) is between 5 and 6 (C5 is 10 wt.-%, C6 is 18 wt.-%). Linear interpolation is easily calculated such that e.g. the 15 wt.-% content carbon number (c_15 value) is calculated to be

5{highest carbon number not yet contributing 15 wt.-%}+[(15% {content of interest}−10%{C5 accumulated content})/(18% {C6 accumulated content}−10%{C5 accumulated content})]=5+[5%/8%]=5+0.625, i.e. carbon number 5.625.

In other words, for determining the c_XX value, the following equation is used:

{highest carbon number not yet contributing XX wt.-%}+[({content of interest: XX wt.-%}−{accumulated content of highest carbon number not yet contributing XX wt.-%})/({accumulated content of lowest carbon number for which accumulated content exceeds XX wt.-%}−{accumulated content of highest carbon number not yet contributing XX wt.-%})]

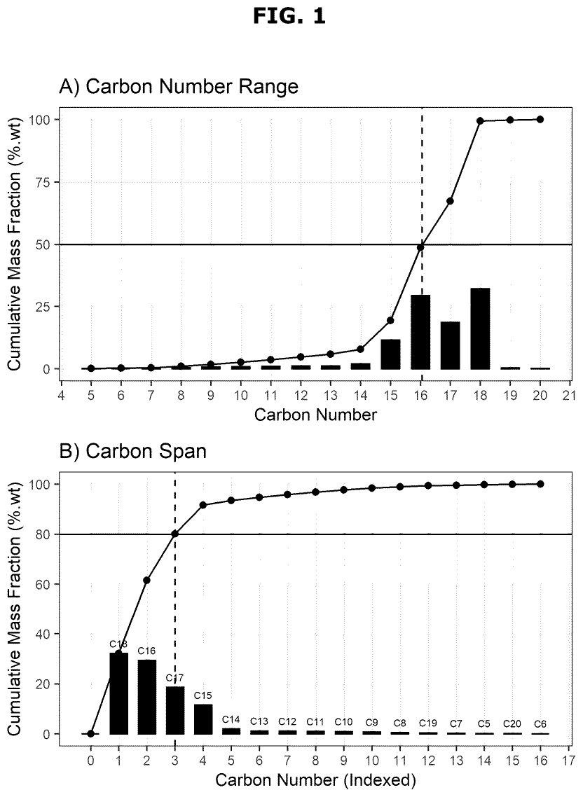

The linear interpolation can be easily understood from the graphical illustration of FIG. 1. In FIG. 1 (graph A), the y-axis represents the accumulated content of compounds and carbon numbers are arranged on the x-axis ordered by their number. The bars represent individual content of compounds with the respective carbon number. The dots represent the accumulated content (cumulative mass fraction) for the respective carbon number and the line graph represents the linear interpolation (i.e. drawing a straight line between neighbouring dots). The carbon number where the line graph crosses the 50% cumulative mass fraction (horizontal line) is the c_50 value, which is slightly above 16 in FIG. 1, as shown by the dotted line.

The IVR, IDR and IQR ranges are less sensitive to tail effects and thus provide more stable results than the carbon range.

Preferably, the higher-boiling fraction has a c_50 value in the range of from 16.5 to 20.0, preferably 16.5 to 19.0, or 17.0 to 18.0. This indicates that the fraction is a rather high-boiling fraction, such as a bottom fraction obtained from fractionation.

In an embodiment, the higher-boiling fraction has a c_50 value of 16.5 or more and an interventile carbon number range (IVR) of 5.0 or less. On other words, it is particularly preferable that the high-boiling fraction be a fraction having a narrow carbon number distribution and being a heavy (high-boiling) fraction having a high c_50 value.

Preferably, the lower-boiling fraction has a c_50 value in the range of from 11.0 to less than 16.5, preferably 12.0 to 16.0, or 14.0 to 16.0. Since a conventional renewable isomeric hydrocarbon composition contains a high share of C18 hydrocarbons, the above-mentioned range indicates that a considerable amount of high-boiling components, in particular C18 and higher-boiling components end up in fraction(s) other than the lower-boiling fraction. Specifically, the lower-boiling fraction may be a heads fraction.

Preferably, the lower-boiling fraction has a content of hydrocarbons having less than 18 carbon atoms (<C18) of 55 wt.-% or more, more preferably 60 wt.-% or more, 65 wt.-% or more, 70 wt.-% or more, 75 wt.-% or more or 80 wt.-% or more. The upper limit may be 100 wt.-% (i.e. the content may for example be in the range 55 wt.-% to 100 wt.-%), but is preferably 99 wt.-% or less, more preferably 98 wt.-% or less, such as 95 wt.-% or less, 92 wt.-% or less, or 90 wt.-% or less.

Preferably, the lower-boiling fraction has a ratio (>C18/<C18) between the content of hydrocarbons having 18 or more carbon atoms (≥C18) and the content of hydrocarbons having less than 18 carbon atoms (<C18) of 0.90 or less, preferably 0.85 or less, 0.80 or less, 0.70 or less, 0.60 or less, 0.50 or less, 0.40 or less or 0.30 or less. The ratio may be as low as 0, but is preferably at least 0.02 (i.e. the ratio may for example be in the range of from 0.02 to 0.90), more preferably at least 0.05, such as at least 0.08, at least 0.10, at least 0.12 or at least 0.15.

Preferably, the higher-boiling fraction has a content of hydrocarbons having 18 or more carbon atoms (≥C18) of 50 wt.-% or more, preferably 55 wt.-% or more, 60 wt.-% or more, 65 wt.-% or more, 70 wt.-% or more, 75 wt.-% or more or 80 wt.-% or more. The upper limit may be 100 wt.-% (i.e. the content may for example be in the range 50 wt.-% to 100 wt.-%), but is preferably 99 wt.-% or less, more preferably 98 wt.-% or less, such as 95 wt.-% or less, 93 wt.-% or less, 91 wt.-% or less, or 90 wt.-% or less.

Preferably, the higher-boiling fraction has a ratio (≥C18/<C18) between the content of hydrocarbons having 18 or more carbon atoms (≥C18) and the content of hydrocarbons having less than 18 carbon atoms (<C18) of 1.0 or more, preferably 1.2 or more, 1.5 or more, 2.0 or more, 3.0 or more, 4.0 or more, 5.0 or more, or 6.0 or more. The ratio may for example be 200.0 or less (i.e. the ratio may for example be in the range of from 1.0 to 200.0), preferably 150.0 or less, such as 100.0 or less, 50.0 or less, 30.0 or less, 20.0 or less, 15.0 or less, 12.0 or less or 10.0 or less.

Preferably, the lower-boiling fraction has an interventile carbon number range (IVR) in the range of from 5.0 to 12.0, preferably 6.0 to 12.0, or 7.0 to 11.0. The lower-boiling fraction may have a rather broad carbon number distribution while still achieving favourable cracking properties. That is, in the lower-boiling fraction, it is possible that the carbon number distribution is narrow, but it is not absolutely necessary. In fact, in view of yield, it is even favourable to allow a certain broadness of the carbon number distribution such that a high share of the isomeric hydrocarbon composition is accessible to the method of the present invention. In particular, it is a preferred option that the isomeric hydrocarbon composition be fractionated into the two fractions such that the total amount of the lower-boiling fraction and the higher-boiling fraction corresponds to 90 wt.-% to 100 wt.-%, preferably at least 95 wt.-% or at least 97 wt.-% of the isomeric hydrocarbon composition fed to fractionation.

Preferably, the lower-boiling fraction has a c_50 value of less than 16.5 and an interventile carbon number range (IVR) in the range of from 5.0 to 12.0.

The step (a) of the present invention may comprise a stage of carrying out the fractionation of the isomeric hydrocarbon composition to provide at least the lower-boiling fraction and the higher-boiling fraction. Alternatively, the renewable cracker feed may be provided by a parallel process or even purchased.

The lower-boiling fraction may have a content of compounds having a weight fraction on the modal carbon number in the range of 20 wt.-% to 40 wt.-%, preferably 22 wt.-% to 37 wt.-%, or 25 wt.-% to 35 wt.-%. This implies that the lower-boiling fraction may have a moderately broad carbon number distribution, i.e. having a pronounced weight fraction at and usually around the modal carbon number. The modal carbon number is the carbon number having the highest abundancy in PIONA analysis.

The lower-boiling fraction preferably has a minimum carbon number (C_min) in the range of from 5 to 8, preferably 5 to 7, such as 5 or 6. The lower-boiling fraction preferably has a maximum carbon number (C_max) in the range of from 14 to 26, preferably 15 to 23, 16 to 22, or 17 to 21. Within these ranges, the effects of the present invention are particularly pronounced. In addition, in particular the C_max range above results in easy evaporation of the renewable cracker feed and in low coking tendency within the conversion section of the thermal cracker.

The lower-boiling fraction preferably has a modal carbon number in the range of from 12 to 17, such as 13 to 17, 14 to 16, or 15 to 16.

The lower-boiling fraction preferably has an interquartile carbon number range (IQR) in the range of 1.5 to 4.0, preferably 2.0 to 3.5, or 2.0 to 3.0. In other words, while the lower-boiling fraction may well have a broader carbon number distribution than the higher-boiling fraction it is nevertheless favourable that this fraction has a certain sharpness, as indicated by the IQR as well. That is, such well-defined fraction(s) makes it possible to specifically adjust the cracking process to the feed properties, thus further improving the yield of valuable products and minimizing side reactions.

For the same reason, the lower-boiling fraction preferably has an interdecile carbon number range (IDR) in the range of 4.0-14.0, 6.0-10.0, 7.0-9.0. Preferably, the lower-boiling fraction has an interventile carbon number range (IVR) in the range of 6.0-11.0, 7.0-11.0, 8.0-10.5.

The lower-boiling fraction preferably has an 80% carbon span (CS_80) in the range of 3.0-9.0, preferably 4.0-8.0, or 4.5-7.0.

In the present invention, the 80% carbon span (CS_80), as well as other carbon spans, is obtained analogously to the c_80 value by linear interpolation. However, while the c_80 value is obtained by sorting the carbon numbers by their numbers (i.e. C1, C2, C3, and so forth), the carbon span (such as CS_80) is obtained based on data in which carbon numbers are sorted in descending order of abundancy, as obtained by PIONA analysis, giving the highest-abundant carbon number the index 1, the next-abundant the index 2 and so on. The CS_80 is then calculated based on linear interpolation (as explained above) by determining the index by which 80% of the sample are represented. FIG. 1 shows the CS_80 value in graph B based on the same sample as shown in graph A, while the x-axis shows indexed carbon numbers. The graph further shows actual carbon number (for reference only) above the bars. In the case of FIG. 1, the CS_80 is very close but slightly below 3 (the index 3 corresponds to C17), as shown by the dotted line.

The lower-boiling fraction preferably has a cloud point of −20° C. or lower, more preferably −30° C. or lower, −40° C. or lower, −45° C. or lower, most preferably-50° C. or lower. The cloud point may for example be in the range of from −70° C. to −20° C. or from −65° C. to −40° C. A low cloud point results in favourable cracking properties and facilitates handling of the renewable cracker feed.

Preferably, the higher-boiling fraction has a higher c_50 value than the isomeric hydrocarbon composition and the lower-boiling fraction has a lower c_50 value than the higher-boiling fraction. Specifically, it is preferable that the higher-boiling fraction be a fraction containing mainly the heavier parts of the isomeric hydrocarbon composition. For example, the higher-boiling fraction may be a bottoms fraction and the lower-boiling fraction may be one of the non-bottoms fractions or the only non-bottoms fraction.

Preferably, the higher-boiling fraction has a c_50 value which is at least 0.5 higher, preferably at least 1.0 higher or at least 1.5 higher, than the c_50 value of the isomeric hydrocarbon composition. This means that the fractional carbon number representing 50 wt.-% of the higher-boiling fraction is increased by at least 0.5 relative to the fractional carbon number representing 50 wt.-% of the isomeric hydrocarbon composition.

Preferably, the lower-boiling fraction has a c_50 value which is at least 0.5 lower, preferably at least 1.0 lower or at least 1.5 lower, than the c_50 value of the higher-boiling fraction.

The higher-boiling fraction preferably has a content of compounds having a weight fraction on the modal carbon number in the range of 40-95 wt.-%, 50-92 wt.-%, 60-90 wt.-%, 65-89 wt.-%, 70-88 wt.-%, 75-87 wt.-%, 76-86 wt.-%, or 77-85 wt.-%.

Preferably, the higher-boiling fraction has a minimum carbon number (C_min) in the range of from 8 to 20, preferably 10 to 18, 11 to 17, 12 to 16,or 13 to 16. Preferably, the higher-boiling fraction has a maximum carbon number (C_max) in the range of from 22 to 40, preferably 24 to 38, 26 to 36, 26 to 35, 27 to 34. Preferably, the higher-boiling fraction has a modal carbon number in the range of from 17 to 22, preferably 18 to 21, 18 to 20, or 18 to 19. Within these ranges, the effects of the present invention have shown to be particularly pronounced.

Preferably, the higher-boiling fraction has the higher-boiling fraction has an interquartile carbon number range (IQR) in the range of 0.1-3.0, 0.2-2.0, 0.3-1.0, 0.4-0.8. Preferably, the higher-boiling fraction has an interdecile carbon number range (IDR) in the range of 0.5-4.0, 0.6-3.0, 0.7-2.0, 0.8 -1.6. Preferably, the higher-boiling fraction has an interventile carbon number range (IVR) in the range of 1.1-5.0, 1.3-4.0, 1.4-3.5, 1.6-3.2, 1.8-3.0, 1.8 -2.8. Preferably, the higher-boiling fraction has an 80% carbon span (CS_80) in the range of 0.1-3.0, such as 0.2-2.5, 0.3-2.0, 0.4-1.6, or 0.5-1.4. As said before for the lower-boiling fraction, having a narrow carbon number distribution is preferable for the method of the present invention. In particular in case of the higher-boiling fraction it is preferable to have a very narrow carbon number distribution which results in the effects of the present invention to be particularly pronounced.

The higher-boiling fraction preferably has a cloud point of −10° C. or lower, preferably −15° C. or lower, −20° C. or lower, −25° C. or lower, −27° C. or lower. Being a higher-coiling fraction, the cloud point is not necessarily as low as for the lower-boiling fraction. The cloud point may for example be in the range of from −60° C. to −10° C. or from −40° C. to −15° C.

The thermal cracking step (b) may be a steam cracking step. Steam cracking is tolerant to possible impurities which are common in renewable material. In addition, the method of the present invention has shown to provide particularly good results when employing steam cracking.

Preferably, the thermal cracking step (b) is conducted at a coil outlet temperature (COT) selected from the range from 780° C. to 900° C., preferably from 805° C. to 865° C., more preferably from 815° C. to 850° C.

The thermal cracking step (b) may be conducted at a coil outlet pressure (COP) selected from the range from 1.3 bar to 6.0 bar, preferably from 1.3 bar to 3.0 bar. In the present invention, a pressure value or range refers to absolute pressure, unless otherwise specified.

The thermal cracking step (b) is preferably conducted in the presence of a thermal cracking diluent. Any conventional thermal cracking diluent(s) may be used in the thermal cracking step (b). Examples of such thermal cracking diluents comprise steam, molecular nitrogen (N₂), or a mixture thereof. Dilution of the thermal cracker feed lowers the hydrocarbon partial pressure in the thermal cracking coils and favours formation of primary reaction products, such as ethylene and propylene. The thermal cracking diluent preferably comprises steam.

The thermal cracking step (b) is preferably conducted in the presence of a thermal cracking diluent at dilution within a range from 0.10 to 0.80, preferably from 0.25 to 0.70, such as 0.35 to 0.50. The dilution refers to a flow rate ratio between thermal cracking diluent and the total cracker feed (flow rate of thermal cracking diluent [kg/h] /flow rate of total cracker feed [kg/h]). The total cracker feed refers to the renewable cracker feed plus optional co-feed(s) and optional additive(s), but excluding diluent.

The individual components of the total cracker feed as well as the diluent(s) may be fed to the thermal cracking furnace as a pre-formed mixture, as separate streams or as a combination of separate stream(s) and pre-formed mixture(s).

The method may comprise performing one or more further cracking operation(s) to provide further cracking effluent(s), wherein step (c) further comprises adding the further effluent(s) and/or fraction(s) thereof before and/or during the separation treatment.

The thermal cracking in step (b) is preferably carried out in the presence of co-feed(s).

Preferably, the content of the renewable cracker feed in the total cracker feed is in the range of from 10 wt.-% to 100 wt.-%, preferably 20 wt.-% to 100 wt.-%, 30 wt.-% to 100 wt.-%, 40 wt.-% to 100 wt.-%, 50 wt.-% to 100 wt.-%, 60 wt.-% to 100 wt.-%, 70 wt.-% to 100 wt.-%, 80 wt.-% to 100 wt.-%, or 90 wt.-% to 100 wt.-%, wherein the total cracker feed refers to the renewable cracker feed plus optional co-feed(s) and optional additive(s). The upper limit may also be 90 wt.-% or 80 wt.-%, i.e. the content may for example be in the range of from 10 wt.-% to 90 wt.-% or from 10 wt.-% to 80 wt.-%.

Employing at least 10 wt.-% renewable cracker feed ensures that the effects of the present invention are remarkably pronounced. The total cracker feed may consist of the renewable cracker feed, i.e. the content thereof may be 100 wt.-%.

The co-feed(s) may comprise a fossil hydrocarbon co-feed. Fossil co-feeds, in particular fossil naphtha, are readily available and highly suitable for thermal cracking. In order to fully benefit from the effects of the present invention, it is preferable that the co-feed(s) have a composition, in particular a carbon number distribution, which is similar to that of the renewable cracker feed. Specifically, the co-feed(s) may comprise a naphtha range feed, a diesel range feed, an aviation fuel range feed, a marine fuel range feed, or a gas oil range feed. In particular when the higher-boiling fraction (or a part thereof) is used as the renewable cracker feed, the co-feed may comprise a heavy fossil fraction, such as a gas oil fraction.

The total cracker feed preferably has a sulphur content in the range of from 20 to 300 ppm by weight, preferably 20 to 250 ppm by weight, more preferably 20 to 100 ppm by weight, and even more preferably 50 to 65 ppm by weight.

The inventors surprisingly found that a (total) cracker feed containing the renewable cracker feed (and optionally co-fed and/or additive) and having a sulphur content within the above-mentioned limits results in a significantly reduced coking tendency during thermal cracking.

As the renewable cracker feed typically has inherently low or no sulphur content, the sulphur may be incorporated in the total cracker feed by using a sulphur-containing co-feed, such as a fossil hydrocarbon feed. The sulphur may also originate, in part or in total, from sulphur-containing additive(s), including conventional cracking additive(s). Specifically, any conventional thermal cracking additive(s) may be added to the renewable cracker feed of the present disclosure, to optional co-feed(s) or to a pre-formed total cracker feed or be co-fed to the thermal cracking furnace or may be added to thermal cracking diluent and thus fed to the thermal cracking furnace. Examples of such conventional thermal cracking additives include sulphur containing species (sulphur additives), such as dimethyl disulphide (DMDS), or carbon disulphide (CS2). DMDS is a particularly preferred sulphur additive. Sulphur additive(s) may be mixed with the renewable cracker feed, with optional co-feed(s) or with a pre-formed total cracker feed before feeding to the thermal cracking furnace. Optionally, sulphur additive(s) may be added by injecting into the thermal cracking furnace a thermal cracking diluent, preferably steam, comprising sulphur additive(s).

The step (a) of providing the renewable cracker feed may for example comprise subjecting an oxygenate bio-renewable feed to hydrotreatment comprising at least hydrodeoxygenation, and to hydroisomerisation, to provide at least an isomerised deoxygenated stream, subjecting at least part of the isomerised deoxygenated stream to fractionation and recovering at least the isomeric hydrocarbon composition, and subjecting at least part of the isomeric hydrocarbon composition to a further fractionation to provide at least the lower-boiling fraction and the higher-boiling fraction. The isomerised deoxygenated stream is suitably a liquid isomerised deoxygenated stream.

Other fraction(s) may be recovered from fractionation in addition to the isomeric hydrocarbon composition, such as but not limited to at least one of a fuel gas fraction, a marine fuel fraction, a naphtha range fraction, a diesel range fraction, an aviation fuel range fraction or electrotechnical fluid fraction. A propane fraction may be recovered from a gas-liquid separation after hydrotreatment. Preferably, one or more fraction(s) usable for liquid transportation fuel(s) are recovered, such as diesel fuel, gasoline fuel, aviation fuel or marine fuel.

An exemplary aviation fuel range fraction may boil within a range from 100° C.-300° C., such as within 150° C.-300° C. An exemplary gasoline fuel range fraction may boil within a range from 25° C.-220° C. An exemplary diesel fuel range fraction may boil within a range from 160° C.-380°C. An exemplary marine fuel range fraction may boil within 180° C.-600° C.

In general, a naphtha range fraction as disclosed herein may refer to a fraction having an initial boiling point of more than 0° C., preferably more than 20° C. or more than 30° C., and a T95 temperature of 220° C. or less, preferably 200° C. or less, 180° C. or less, 160° C. or less, 140° C. or less. The naphtha range fraction may have a T99 temperature of 220° C. or less, preferably 200° C. or less, 180° C. or less, 160° C. or less, 140° C. or less, or a final boiling point of 220° C. or less, preferably 200° C. or less or 180° C. or less.

Unless specified to the contrary, the boiling characteristics in the present invention, such as the T95 temperature (95 vol-% recovered), the T99 temperature (99 vol-% recovered), the final boiling point, the initial boiling point, the T5 temperature (5 vol-% recovered) and the T10 temperature (10 vol-% recovered) are as determined in accordance with EN ISO 3405-2019.

In the present invention, the hydroisomerisation may be conducted in the same hydrotreatment as the hydrodeoxygenation. In other words, the hydroisomerisation may be part of the hydrotreatment comprising at least hydrodeoxygenation. Alternatively, or in addition, the hydroisomerisation may be conducted in a further hydrotreatment after the hydrotreatment comprising at least hydrodeoxygenation.

Hydrotreatment comprising hydrodeoxygenation and hydroisomerisation may for example be carried out by means of a catalyst or catalyst system achieving both hydrodeoxygenation and hydroisomerisation in a single step.

Step (a) may further comprise a gas-liquid separation stage after the hydrotreatment and/or after the further hydrotreatment, and recovering at least one gaseous stream and the isomerised deoxygenated stream. The gaseous stream(s) may be subjected to a propane separation process to provide a stream enriched in propane and a stream depleted in propane. At least part of the propane from the stream enriched in propane may be subjected to dehydrogenation, preferably catalytic dehydrogenation, to produce propylene. Gaseous streams from gas-liquid separations may be combined or may be processed individually. A gas-liquid separation further provides a liquid stream. At least part of the liquid stream recovered after the hydrotreatment and/or after the further hydrotreatment may be employed as the isomerised deoxygenated stream.

In an embodiment, the renewable cracker feed may be obtainable or obtained by a method comprising subjecting an oxygenate bio-renewable feed to hydrotreatment comprising at least hydrodeoxygenation, to hydroisomerisation and to gas-liquid separation, to provide an isomerised deoxygenated stream, feeding the isomerised deoxygenated stream to a first distillation column, preferably a stabilisation column, to obtain at least a naphtha range fraction and a stabilized heavy liquid fraction, and feeding at least part of the stabilized heavy liquid fraction as the isomeric hydrocarbon composition to a second distillation column and recovering at least the lower-boiling fraction and the higher-boiling fraction.

A stage of obtaining a liquid paraffinic hydrocarbon intermediate is disclosed in WO 2021/094655 A1, which is herewith incorporated by reference in its entirety. In particular, this stage is disclosed in WO 2021/094655 A1 with reference to FIGS. 1 and 2 and accompanying text, which are herewith specifically incorporated by reference. In this respect, the liquid paraffinic hydrocarbon intermediate corresponds to the stabilized heavy liquid fraction mentioned above.

In general, the following procedure may be employed:
The isomerised deoxygenated stream may be directed to stabilization in a stabilization column, preferably at lowered pressure compared to isomerization, wherein an overhead fraction is formed in addition to a stabilized heavy liquid fraction. The overhead fraction comprises hydrocarbons in the naphtha range (e.g. C4-C8). This overhead fraction from the stabilization may be recovered and used as a gasoline component, or preferably, it may be recycled back to the stabilization for refluxing, preferably into the stabilization column. Thus, preferably according to the present invention the oxygenate bio-renewable is subjected to hydrotreatment and isomerization, and the liquid product thereof is forwarded to stabilization at a pressure lower than the isomerization pressure. The recycled amount of the hydrocarbons in the naphtha range used for refluxing may be from 80 wt.-% or more, preferably 90 wt.-% or more, such as from 90 to 95 wt.-%, of the formed hydrocarbons in the naphtha range at the stabilization column overhead. A high recycle amount aids in the subsequent separation of the lighter and heavier fractions, and increases the yields of the obtained lower-boiling and higher-boiling fractions. Naturally, a higher refluxing requires adjustment of the equipment for higher flow. Thus, preferably according to the present invention during stabilization an overhead fraction comprising hydrocarbons in the naphtha range (C4-C8) is formed, and an amount of 60 wt.-% or more, such as 90 wt.-% or more, such as from 90 to 95 wt.-%, of the formed hydrocarbons in the naphtha range at the stabilization column overhead is recycled back to the stabilization.

The isomerised deoxygenated stream mentioned above may have an i-paraffins content of at least 65 wt.-%, preferably at least 70 wt.-%, at least 75 wt.-%, at least 80 wt.-%, at least 85 wt.-% or at least 90 wt.-%.

The method may further comprise derivatisation of at least part of the light olefin(s) to obtain one or more derivate(s) of the light olefin(s) as bio-monomer(s), such as acrylic acid, acrylonitrile, acrolein, propylene oxide, ethylene oxide, 1,4-butanediol, 1,2-butanediol, 1,3-butanediol, 2,3-butanediol, adiponitrile, hexamethylene diamine (HMDA), hexamethylene diisocyanate (HDI), (methyl) methacrylate, ethylidene norboreen, 1,5,9-cyclododecatriene, sulfolane, 1,4-hexadiene, tetrahydrophthalic anhydride, valeraldehyde, 1,2-butyloxide, n-butyl mercaptan, o-sec-butylphenol, propylene, octene and sec-butyl alcohol.

In the present invention, it is preferable that the renewable cracker feed be obtainable by a method comprising hydrotreatment and isomerisation of an oxygenate bio-renewable feed.

Specific embodiments of the present invention relate to an integrated method and to a biorefinery adapted to carry out at least such an integrated method. For example, it is possible that at least part of the lower-boiling fraction is subjected to the thermal cracking step (c) in a first thermal cracking furnace and at least part of the higher-boiling fraction is subjected to the thermal cracking step (c) in a second thermal cracking furnace. Similarly, it is possible that at least part of the lower-boiling fraction and at least part of the higher-boiling fraction are alternately subjected to the thermal cracking step (c) in the same thermal cracking furnace.

Thus, one can make use of both components while still achieving the benefits of the present invention, i.e. superior cracking properties over the isomeric hydrocarbon composition.

It is also possible that at least part of the lower-boiling fraction is subjected to the thermal cracking step (c) and at least part of the higher-boiling fraction is recovered as a specialty fluid or component thereof, such as an electrotechnical fluid, lubricant, coolant or component thereof, and/or as a fuel component, such as a marine fuel component. It is further possible that at least part of the higher-boiling fraction is subjected to the thermal cracking step (c) and at least part of the lower-boiling fraction is recovered as a fuel component, preferably as an aviation fuel component.

Further, it is possible that a part of the lower-boiling fraction is subjected to the thermal cracking step (c) and another part of the lower-boiling fraction is recovered as a fuel component, preferably as an aviation fuel component. Similarly, it is possible that a part of the higher-boiling fraction is subjected to the thermal cracking step (c) and another part of the higher-boiling fraction is recovered as a specialty fluid or component thereof, such as an electrotechnical fluid, lubricant, coolant or component thereof, and/or as a fuel component, such as a marine fuel component.

All of the above options for an integrated method have in common the benefit to provide flexibility to the integrated method, i.e. being able to adjust the method in accordance with demand of various components. For example, from time to time one can collect the respective products in varying amounts depending on market need, price, desired composition and/or quality or based on the availability of raw material, such as the oxygenate bio-renewable feed to maximise the value of the various product streams.

The method of the present invention may further comprise a step (e) of (co) polymerizing at least one of the light olefin(s) separated in step (c) and/or at least one of the bio-monomer(s), optionally together with other (co) monomer(s) and/or after optional further purification, to produce a biopolymer composition.

The polymer may further be processed to produce a sanitary article, a construction material, a packaging material, a coating composition, a paint, a decorative material, such as a panel, an interior part of a vehicle, such as an interior part of a car, a rubber composition, a tire or tire component, a toner, a personal health care article, a part of a consumer good, a part or a housing of an electronic device, a film, a moulded product, a gasket, optionally together with other components.

The present invention further relate to a biopolymer composition obtainable by the method of the present invention.

### EXAMPLES

The present invention is further illustrated by way of Examples. It is to be understood that the Examples shall in no way limit the present invention.

Thermal cracking of five feed compositions (C1 to C3, E1 and E2) was evaluated. The composition C1 corresponds to a renewable composition obtained by hydrotreatment comprising hydrodeoxygenation and medium severity hydroisomerisation of an oxygenate bio-renewable feed and fractionation to provide a material mainly in the diesel fuel range. The composition C2 corresponds to a renewable composition obtained by hydrotreatment comprising hydrodeoxygenation and medium-high severity hydroisomerisation of an oxygenate bio-renewable feed and fractionation to provide a material mainly in the diesel fuel range. The composition C3 corresponds to a renewable composition obtained by hydrotreatment comprising hydrodeoxygenation and high severity hydroisomerisation of an oxygenate bio-renewable feed and fractionation to provide a material mainly in the diesel fuel range. Composition C3 corresponds to a isomeric hydrocarbon composition mentioned in the present specification.

The compositions E1 and E2 correspond to a lower-boiling fraction and a higher-boiling fraction mentioned in the present specification, which are each obtained by fractionation of a composition which was produced similar to the method employed for composition C3, but under conditions suppressing generation of iP3+ species. PIONA data, carbon number analysis based on PIONA data, cloud point and iP3+ analysis of these composition are shown in the following Table 1:

TABLE 1

| Property | C1 | C2 | C3 | E1 | E2 |
|---|---|---|---|---|---|
| nP [%] | 29.1 | 8.4 | 5.2 | 3.4 | 2.3 |
| iP [%] | 66.9 | 91.4 | 94.0 | 95.6 | 96.6 |
| Olefins [%] | 0.0 | 0.0 | 0.0 | 0.0 | 0.0 |
| Naphthenes [%] | 3.1 | 0.0 | 0.8 | 1.0 | 1.1 |
| Aromatics [%] | 0.7 | 0.1 | 0.0 | 0.0 | 0.0 |
| unidentified [%] | 0.1 | 0.0 | 0.0 | 0.0 | 0.0 |
| Total [%] | 100 | 100 | 100 | 100 | 100 |
| Cloud point [° C.] | −2.6 | −36.0 | −48.4 | −58.1 | −30.1 |
| iP3+ [%] | 2.9 | 10.5 | 15.8 | 13.1 | 14.0 |
| iP3+/iP | 0.043 | 0.115 | 0.168 | 0.137 | 0.145 |
| Modal C-no | 18 | 18 | 18 | 16 | 18 |
| wt.-% @ modal C | 33.3 | 32.1 | 26.5 | 28.5 | 81.8 |
| C_min | 5 | 5 | 5 | 6 | 14 |
| C_max | 21 | 20 | 29 | 19 | 30 |
| C range | 16 | 15 | 24 | 13 | 16 |
| c_50 | 16.1 | 16.1 | 15.5 | 15.5 | 17.5 |
| IQR | 2.1 | 2.0 | 4.0 | 2.5 | 0.6 |
| IDR | 3.4 | 3.5 | 8.3 | 7.7 | 1.2 |
| IVR | 3.9 | 5.6 | 9.7 | 9.4 | 2.1 |
| CS @ 80% | 3.0 | 3.0 | 6.2 | 5.2 | 1.0 |
| CS @ 90% | 3.7 | 3.9 | 8.7 | 8.1 | 1.8 |
| Mass < C18 [%] | 65.9 | 67.3 | 72.9 | 82.0 | 12.9 |
| Mass ≥ C18 [%] | 34.0 | 32.7 | 27.1 | 18.0 | 87.1 |
| ≥C18/<C18 | 0.52 | 0.49 | 0.37 | 0.22 | 6.75 |

### Comparative Examples 1-3 and Examples 1 to 4

The compositions were subjected to steam cracking at a coil outlet temperature (COT) 820° C., dilution (water/oil ratio) of 0.5 and a coil outlet pressure (COP) of 1.7 bar (absolute).

The resulting yields of relevant products are shown in Table 2 below. Additionally, the compositions E1 and E2 were subjected to cracking at 880° C., leaving the remaining conditions the same. Results are shown in Table 3 below in comparison to Examples 1 and 2 (at) 820°).

TABLE 2

| | Comp. Ex1 | Comp. Ex2 | Comp. Ex3 | Ex1 | Ex2 |
|---|---|---|---|---|---|
| Sample | C1 | C2 | C3 | E1 | E2 |
| Products | | | | | |
| HVO* | 63.6 | 62.2 | 63.5 | 68.8 | 69.9 |
| Ethylene | 32.7 | 29.6 | 28.9 | 30.3 | 32.0 |
| Propylene | 18.1 | 18.7 | 19.4 | 20.9 | 20.9 |
| 1,3-Butadiene | 6.8 | 6.7 | 6.8 | 8.0 | 8.2 |
| C4 monoolefin | 6.0 | 7.3 | 8.3 | 9.6 | 8.8 |
| BTX** | 5.3 | 9.7 | 9.7 | 4.3 | 4.8 |
| Benzene | 3.8 | 6.7 | 6.9 | 2.6 | 3.2 |
| AC&MAPD^{#} | 1.3 | 1.4 | 1.4 | 0.5 | 0.6 |

*HVO = high value olefins, i.e. ethylene, propylene, 1-butene, i-butene, 2-butene, 1,3 butadiene
**BTX = benzene, toluene and xylenes
^{#}Ac&MAPD = acetylene, methyl acetylene, propadiene

TABLE 3

| | Example 1 | Example 2 | Example 3 | Example 4 |
|---|---|---|---|---|
| Sample | E1 @ | E2 @ | E1 @ | E2 @ |
| | 820° C. | 820° C. | 880° C. | 880° C. |
| Products | | | | |
| HVO | 68.8 | 69.9 | 58.1 | 58.9 |
| Ethylene | 30.3 | 32.0 | 33.3 | 34.7 |
| Propylene | 20.9 | 20.9 | 14.9 | 14.8 |
| 1.3-Butadiene | 8.0 | 8.2 | 6.1 | 6.4 |
| C4 monoolefin | 9.6 | 8.8 | 3.8 | 3.1 |
| BTX | 4.3 | 4.8 | 11.0 | 10.9 |
| Benzene | 2.6 | 3.2 | 8.1 | 8.4 |
| Ac&MAPD | 0.5 | 0.6 | 0.5 | 1.2 |

It can be seen that increasing the isomerisation degree decreases the cloud) point allowing easier handling and storage of the feed material. Additionally 10 the yield of highly valued propylene increases with increasing isomerisation in combination with the unwanted Benzene in the comparative examples.

In the inventive examples where iP content is kept high but the amount of iP3+ substitutions are minimised in combination with more uniform carbon number ranges such as low IQR and/or low carbon spans such as CS @ 80% (CS_80) the benzene formation can be suppressed in preference for high value olefin formation, additionally formation of light contaminants such as acetylene, methylacetylene and propadiene are reduced.

Table 3 shows that the materials perform over a broad temperature range which could allow further optimisation of the product yields, especially interesting is conversion at lower temperatures as this would promote propylene formation at reduced benzene formation and save on valuable heating duty further facilitating low carbon emissions in production.

1.-23. (canceled)

24. A method comprising:
(a) providing a renewable cracker feed from an isomeric hydrocarbon composition, the renewable cracker feed being obtainable by fractionating an isomeric hydrocarbon composition having an i-paraffins content of 85.0 wt.-% or more and a carbon range in a range of from 20 to 32 into at least a lower-boiling fraction and a higher-boiling fraction, with at least part of the lower-boiling fraction or at least part of the higher-boiling fraction being the renewable cracker feed;
(b) thermally cracking the renewable cracker feed in a thermal cracking furnace, optionally together with co-feed(s) and/or additive(s); and
(c) subjecting an effluent of the thermal cracking furnace to a separation treatment to provide at least a light olefin(s) fraction.

25. The method according to claim 24, comprising:
fractionating the isomeric hydrocarbon composition having an i-paraffins content of 85.0 wt.-% or more and a carbon range in a range of from 20 to 32 into at least a lower-boiling fraction and a higher-boiling fraction, wherein the isomeric hydrocarbon composition has a c_50 value in a range of from 14.0 to 22.0, and/or from 14.0 to 20.0, and/or from 15.0 to 20.0.

26. The method according to claim 24, wherein:
both the lower-boiling fraction and the higher-boiling fraction have, independently of one another, an i-paraffins content of 92.0 wt.-% or more, and/or 93.0 wt.-% or more, 94.0 wt.-% or more, and/or 95.0 wt.-% or more.

27. The method according to claim 24, wherein:
both the lower-boiling fraction and the higher-boiling fraction have, independently of one another, a ratio (iP3+/iP) between i-paraffins having more than three branches (IP3+) to total i-paraffins (iP) of 0.164 or less, and/or 0.160 or less, 0.155 or less, and/or 0.150 or less.

28. The method according to claim 24, wherein:
both the lower-boiling fraction and the higher-boiling fraction have, independently of one another, a total content of i-paraffins having more than three branches (iP3+) of 10.50 wt.-% or more, and/or 10.50 to 16.00, 11.00 to 15.50, 11.00 to 15.50, 11.00 to 15.00, and/or 12.00 to 15.00 relative to total paraffins.

29. The method according to claim 24, wherein:
both the lower-boiling fraction and the higher-boiling fraction have, independently of one another, a cloud point of −10° C. or lower, and/or −15° C. or lower, and/or −20° C. or lower; and/or wherein both the lower-boiling fraction and the higher-boiling fraction have, independently of one another, a total content of olefins, aromatics and naphthenes of 0.1 wt.-% to 10.0 wt.-%, and/or 0.1 wt.-% to 8.0 wt.-%, 0.1 wt.-% to 6.5 wt.-%, 0.2 wt.-% to 6.0 wt.-%, 0.5 wt.-% to 5.5 wt.-%, 0.5 wt.-% to 5.0 wt.-%, 0.8 wt.-% to 5.0 wt.-%, 0.9 wt.-% to 5.0 wt.-%, 1.0 wt.-% to 5.0 wt.-%, 1.1 wt.-% to 5.0 wt.-%, and/or 1.2 wt.-% to 5.0 wt.-%; and/or wherein both the lower-boiling fraction and the higher-boiling fraction have, independently of one another, a modal carbon number in the range of from 11 to 21, and/or from 14 to 20, and/or from 16 to 18.

30. The method according to claim 24, wherein:
the higher-boiling fraction has a c_50 value in a range of from 16.5 to 20.0, and/or 16.5 to 19.0, and/or 17.0 to 18.0.

31. The method according to claim 24, wherein:
the higher-boiling fraction has a modal carbon number in a range of from 17 to 22, and/or 18 to 21, 18 to 20, and/or 18 to 19.

32. The method according to claim 24, wherein:
the higher-boiling fraction has an interdecile carbon number range (IDR) in a range of 0.5 -4.0, 0.6-3.0, 07.-2.0, and/or 0.81.6.

33. The method according to claim 24, wherein:
the higher-boiling fraction has an 80% carbon span (CS_80) in a range of 0.1-3.0, and/or 0.2-2.5, 0.3-2.0, 0.4-1.6, and/or 0.5-1.4.

34. The method according to claim 24, wherein:
the higher-boiling fraction has an interventile carbon number range (IVR) of 5.0 or less, and/or 4.5 or less, 4.0 or less, 3.5 or less, 3.0 or less, 2.5 or less, and/or 2.3 or less.

35. The method according to claim 24, wherein:
the lower-boiling fraction has a c_50 value in a range of from 11.0 to less than 16.5, and/or 12.0 to 16.0, and/or 14.0 to 16.0.

36. The method according to claim 24, wherein:
the lower-boiling fraction has a modal carbon number in a range of from 12 to 17, and/or 13 to 17, 14 to 16, and/or 15 to 16.

37. The method according to claim 24, wherein:
the lower-boiling fraction has an interdecile carbon number range (IDR) in a range of 4.0 -14.0, 6.0-10.0, and/or 7.0-9.0.

38. The method according to claim 24, wherein:
the lower-boiling fraction has an 80% carbon span (CS_80) in a range of 3.0-9.0, and/or 4.0-8.0, and/or 4.5-7.0.

39. The method according to claim 24, wherein:
the lower-boiling fraction has an interventile carbon number range (IVR) in a range of from 5.0 to 12.0, and/or 6.0 to 12.0, and/or 7.0 to 11.0.

40. The method according to claim 24, comprising:
(A) subjecting at least part of the lower-boiling fraction to thermal cracking in a first thermal cracking furnace, and subjecting at least part of the higher-boiling fraction to thermal cracking in a second thermal cracking furnace; and/or
(B) subjecting at least part of the lower-boiling fraction and at least part of the higher-boiling fraction to the thermal cracking in a same thermal cracking furnace; and/or
(C) subjecting at least part of the lower-boiling fraction to the thermal cracking and at least part of the higher-boiling fraction is recovered as a specialty fluid or component thereof, or as an electrotechnical fluid, lubricant, coolant or component thereof, and/or as a fuel component, and/or as a marine fuel component; and/or
(D) recovering at least part of the higher-boiling fraction to the thermal cracking and at least part of the lower-boiling fraction as a fuel component, and/or as an aviation fuel component; and/or
(E) recovering a part of the lower-boiling fraction to the thermal cracking and another part of the lower-boiling fraction as a fuel component, and/or as an aviation fuel component; and/or
(F) recovering a part of the higher-boiling fraction to the thermal cracking and another part of the higher-boiling fraction as a specialty fluid or component thereof, such as an electrotechnical fluid, lubricant, coolant or component thereof, and/or as a fuel component, and/or a marine fuel component.

41. The method according to claim 24, wherein:
the lower-boiling fraction has a minimum carbon number (C_min) in a range of from 5 to 8 and a maximum carbon number (C_max) in a range of from 14 to 26, and/or a minimum carbon number (C_min) in a range of from 5 to 7 and a maximum carbon number (C_max) in a range of from 15 to 23, a minimum carbon number (C_min) of 5 or 6 and a maximum carbon number (C_max) in a range of from 16 to 22, and/or a minimum carbon number (C_min) of 5 or 6 and a maximum carbon number (C_max) in a range of from 17 to 21.

42. The method according to claim 24, wherein the higher-boiling fraction has a minimum carbon number (C_min) in a range of from 8 to 20 and a maximum carbon number (C_max) in a range of from 22 to 40, and/or a minimum carbon number (C_min) in a range of from 10 to 18 and a maximum carbon number (C_max) in a range of from 24 to 38, a minimum carbon number (C_min) in a range of from 11 to 17 and a maximum carbon number (C_max) in a range of from 26 to 36, a minimum carbon number (C_min) in a range of from 12 to 16 and a maximum carbon number (C_max) in a range of from 26 to 35, and/or a minimum carbon number (C_min) in a range of from 13 to 16 and a maximum carbon number (C_max) in a range of from 27 to 34.

43. The method according to claim 24, wherein:
the thermal cracking is a steam cracking; and/or wherein the thermal cracking is carried out in a presence of co-feed(s).

44. The method according to claim 24, wherein:
the renewable cracker feed is obtained by:
subjecting an oxygenate bio-renewable feed to hydrotreatment including at least hydrodeoxygenation, to hydroisomerisation and to gas-liquid separation, to provide an isomerised deoxygenated stream;
feeding the isomerised deoxygenated stream to a first distillation column, and/or a stabilisation column, to obtain at least a naphtha range fraction and a stabilized heavy liquid fraction; and
feeding at least part of the stabilized heavy liquid fraction as the isomeric hydrocarbon composition to a second distillation column and recovering at least the lower-boiling fraction and the higher-boiling fraction.

45. The method according to claim 24, comprising:
derivatisation of at least part of the light olefin(s) to obtain one or more derivate(s) of the light olefin(s) as bio-monomer(s); and
(co)polymerizing at least one of the light olefin(s) separated and/or at least one of the bio-monomer(s), optionally together with other (co) monomer(s) and/or after optional further purification, to produce a biopolymer composition.

46. A biopolymer composition obtained by the method according to claim 45.
